(19) United States
(12) Patent Application Publication
(10) Pub. No.: US 2012/0149258 A1
(43) Pub. Date: Jun. 14, 2012

(54) SYSTEM, METHOD AND APPARATUS FOR CONNECTING BATTERY CELLS

(76) Inventor: Steven Tartaglia, Safety Harbor, FL (US)

(21) Appl. No.: 13/400,194

(22) Filed: Feb. 20, 2012

Related U.S. Application Data
(63) Continuation-in-part of application No. 12/849,062, filed on Aug. 3, 2010.

(51) Int. Cl. H01R 13/02; B23K 11/10; B23K 31/02

(52) U.S. Cl. 439/890; 228/101; 219/91.2

(57) ABSTRACT

A battery terminal strip for connecting to a terminal of at least one battery cell where the battery terminal strip includes four weld points formed in a strip of metal for each battery cell. Each of the weld points has a protrusion on a first surface of the strip of metal such that the protrusion contacts a terminal of the battery cell. The result is an air gap between the first surface of the strip of metal and the terminal of the battery cell. The air gap reduces heat transfer from the strip of metal to the battery during welding. A cross-cut is formed/cut in the strip of metal. Each segment of the cross-cut creates a gap in the strip of metal such that each gap is between two different weld points of the four weld points.

### CROSS-REFERENCE TO RELATED APPLICATION

This is a Continuation-in-part of U.S. patent application titled “SYSTEM, METHOD AND APPARATUS FOR CONNECTING BATTERY CELLS,” Ser. No. 12/849,062, attorney docket 3044.6, inventor Steven Tartaglia, filed Aug. 3, 2010.

### FIELD

This invention relates to the field of battery packs and more particularly to a system for connecting battery cells in series and/or parallel within a battery pack.

### BACKGROUND

Multiple battery cells are often integrated into a single battery pack. Such battery packs are often used, for example, in portable computers, power tools and other devices. A majority of such battery packs include rechargeable battery cells such as lithium ion, nickel metal hydride or nickel cadmium battery cells.

The battery cells are often arranged in series, parallel or series/parallel arrangements to create battery packs that deliver either a higher voltage (serial), higher current (parallel) or both (series/parallel). To connect the individual cells, often terminal strips are spot welded to terminals of the cells, providing a conductive path between terminals of the battery cells. Spot welders use various technologies to physically and electrically bond the terminal strips to the battery terminals. For example, many spot welders use a capacitive discharge in a technique called fusion welding. This allows welding of highly conductive metals such as copper and brass as well as more resistive metals such as steel and nickel.

Another method of interconnecting battery cells in a battery pack is soldering. In this, the terminal is soldered to the terminal strip using a lower melting point metal such as lead, tin or silver.

All methods of interconnecting battery cells introduce heat into the battery cells. For some battery cells, in particular lithium ion battery cells, excess heat will damage the battery cells. For example, in lithium ion cells, excess heat applied to the battery terminal causes the lithium and cathode separator within the cell to melt. The separator (between the lithium cathode cap and the cathode) becomes perforated and the anode and cathode become welded together causing an internal short, thereby reducing the open circuit battery cell voltage and/or electrical capacity. Therefore, the battery cell loses functionality and, in some cases, bursts.

What is needed is a terminal strip system that will reduce heat transfer to the battery cells during welding.

### SUMMARY

In one embodiment, a battery terminal strip for connecting to a terminal of at least one battery cell is disclosed. The battery terminal strip includes a strip of metal having four weld points formed in the strip of metal for each battery cell (e.g. eight weld points for two battery cells, etc.). Each of the weld points has a protrusion on a first surface of the strip of metal such that the protrusion contacts a terminal of the battery cell of the at least one battery cell thereby forming an air gap between the first surface of the strip of metal and the terminal of the battery cell, thereby reducing heat transfer from the strip of metal to the battery during welding. A cross-cut is formed/cut in the strip of metal. Each segment of the cross-cut creates gaps in the strip of metal such that each gap is between two different weld points of the four weld points.

In another embodiment, a method of connecting a battery cell to a terminal strip is disclosed including positioning a battery terminal strip that has four weld points against the battery terminal of the battery cell such that protrusions of the weld points contact a surface of the battery terminal and an air gap separates the rest of the terminal strip from the battery terminal. A cross-cut gap separates each pair of weld points as well. The protrusions of the weld points are sequentially fused to the battery terminal by discharging a spot welder sequentially at each of the weld points.

In another embodiment, a battery terminal strip for connecting to a terminal of at least one battery cell is disclosed includes a strip of metal having sets of four weld points formed in the strip of metal. Each of the weld points has a protrusion on a first side of the strip of metal such that the protrusion extends outwardly from the surface of the first side of the strip of metal such that an air gap will exist between the first surface of the strip of metal and an object to which the protrusions contact. Slits or gaps are cut or formed in the strip of metal between each two of the four weld points and these gaps connect to form a cross-cut gap.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a plan view of a typical battery cell interconnection system of the prior art.

FIG. 2 illustrates a perspective view of a typical battery cell interconnection system of the prior art.

FIG. 3 illustrates a plan view of an improved battery terminal strip.

FIG. 4 illustrates a perspective view of the improved battery terminal strip.

FIG. 5 illustrates a cross sectional view of the improved battery terminal strip welded to terminals of battery cells.

FIG. 6 illustrates a cross sectional view of two of the improved battery terminal strip welded to terminals of the battery cells.

FIG. 7 illustrates a perspective view of the improved battery terminal strip welded to terminals of battery cells.

FIG. 8 illustrates a perspective view of the improved battery terminal strip welded to terminals of battery cells.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

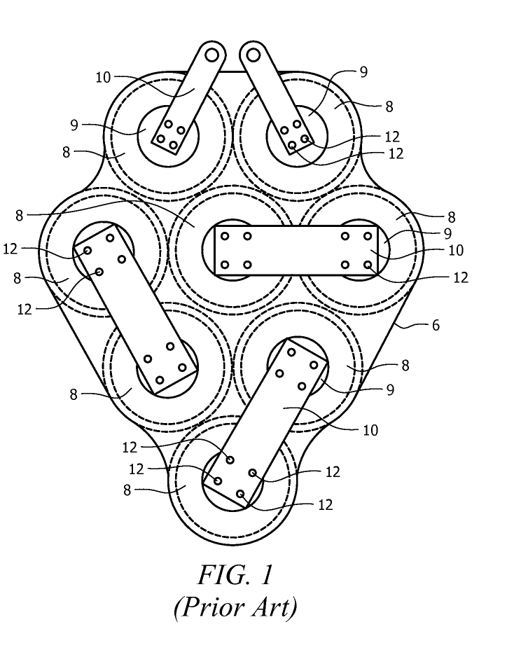

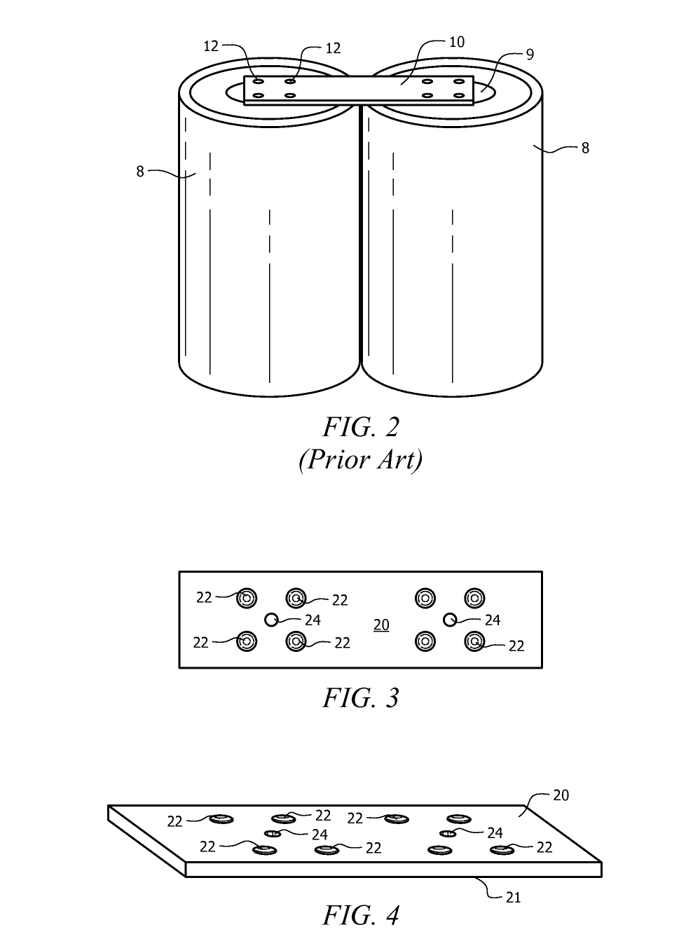

Referring to FIGS. 1 and 2, a typical battery cell interconnection system of the prior art is shown. In this example, the battery cell terminals 9 (e.g. positive terminal or negative terminal) of battery cells 8 that make up a battery pack are held together by a plastic sheet 6. Conductive connections are made between the battery cell terminals 9 using flat strips of metal called terminal strips 10 that are spot welded to the battery cell terminals 9, typically using capacitive discharge welding techniques. One disadvantage of this interconnection method is heat conduction into the battery cells 8. The typical spot welding methods such as capacitive discharge spot welding often generate high amounts of heat, heating the terminal strips 10. After welding, the heat conducts across the terminal strip 10. Being that the terminal strip 10 is flat; a large bottom surface area of the terminal strip 10 is in contact with the battery cell terminals 9. During spot welding, heat conducts from the terminal strip 10 to the battery cell terminals 9 and into the battery cell 8. Many types of battery cells 8 are damaged by certain temperatures, especially lithium ion battery cells 8. After spot welding, the individual welds pressure points 12 created by the spot welding device are noticeable on the top surface of the terminal strip 10.

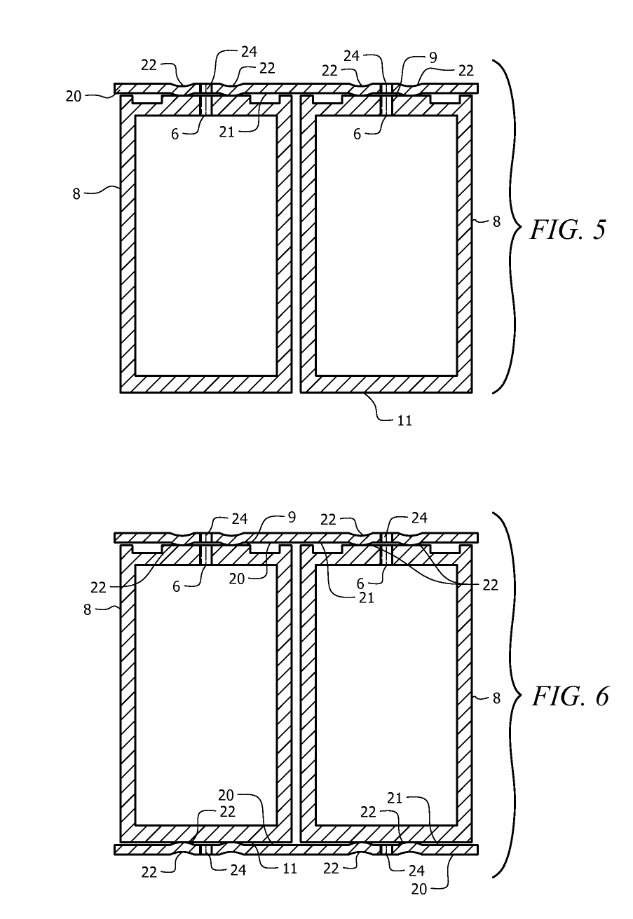

Another disadvantage of this interconnection method is the terminal strip 10 blocks the battery cell 8 vent hole (not visible because it is blocked by the terminal strip 10). Many battery technologies, such as lithium ion, include a vent hole 6 (see FIGS. 5 and 6) in one of the terminals 9 for venting of gasses that are produced during, for example, over discharging or over charging or other failures. The vent holes 6 provide an escape for these gasses, thereby preventing pressure buildup and potential bursting or explosion. The terminal strips 10 of the prior art cover the vent holes 6 and reduce the amount of gasses that are able to effectively escape during, for example, over discharging or over charging or other failures, leading to potentially bursting or an explosion.

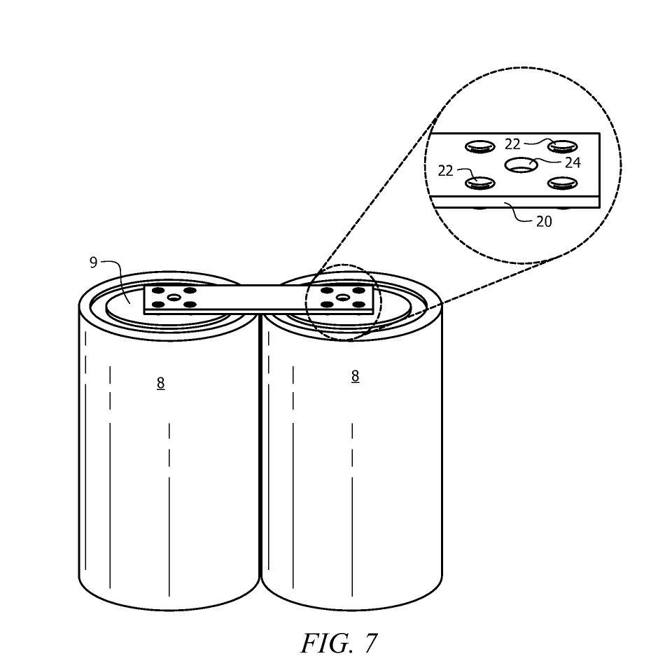

Referring to FIGS. 3 through 7, an improved battery cell interconnection system is shown. In this example of the improved terminal strips 20, weld points 22 are provided to improve the process of spot welding while reducing the flow of heat from the welder into the battery cells 8. The weld points 22 are formed indentations in the terminal strips 20 made either by molding or forming a metal strip made of, for example, steel, nickel, brass, copper or an alloy of such. The weld points 22 have protrusions extending out from a surface that contacts the battery terminal 9/11. The protrusions space the terminal strip 20 from the battery cell terminals 9/11, providing an air gap between the battery cell terminals 9/11 and the bottom surface of the terminal strip 20. In a preferred embodiment, the weld points 22 protrude approximately 0.006 inches from the surface of the terminal strip 20, though any depth of weld point 22 is anticipated.

As the spot welder discharges energy at the weld points 22, intense heat bonds (welds) the protrusions of the weld points 22 to the battery terminal 9/11. Because the terminal strip 20 is made of metal which is a good conductor of heat, during the welding process, residual heat conducts across the terminal strip 20. The weld points 22 create an air gap (e.g., a 0.006 inch air gap) between the terminal strip 20 and the battery terminals 9/11. Since air is a poor conductor of heat, more of the heat generated at the weld points 22 conducts down the terminal strip 20 instead of conducting through the battery cell terminal 9/11 and into the battery cell 8, thereby reducing heating of the battery cells 8. Eventually, the heat conducts into the air and into neighboring battery cells 8, but the maximum temperature allowed by the manufacture of the battery cells 8 is not exceeded by the welds made at the battery cell 8.

The vent holes 24 in the battery cell terminals 20 provide an escape mechanism for gasses that build up within the battery cells 8 that escape from the battery vent holes 6 when, for example, the battery cell 8 is over charged, over discharged or damaged. In some embodiments, a terminal strip vent hole 24 is formed or molded in the terminal strip 20. The terminal strip vent holes 24 in the battery terminal strip 20 align with the vent holes 6 in the battery cells 8 to provide maximum exhaust surface area should venting occur.

To connect a battery cell 9 to a terminal strip 20, the battery terminal strip 20 is positioned against at battery cell terminal 9/11 of the battery cell 8 such that the protrusions of the weld points 22 contact or touch the battery cell terminal 9/11. If the battery terminal 9/11 has a vent hole 6, the optional terminal strip vent hole 24 is aligned with the vent hole 6 of the battery cell terminal 9/11. An electrode of a spot welder contacts the weld points 22 and discharges to fuse the protrusions of the weld points 22 to the battery cell terminal 9/11. The steps are repeated for subsequent weld points 22, optionally waiting for the terminal strip 20 and the battery cell terminal 9/11 to cool between weld steps. In embodiments in which the terminal strip 20 is a copper strip 20, the spot welder electrodes are preferred to be resistive electrode. It is preferred, though not required, that these resistive electrodes be made of molybdenum. Other electrodes made from copper, copper-tungsten (AMPCOLOY) and tungsten do not create as good of a weld as molybdenum.

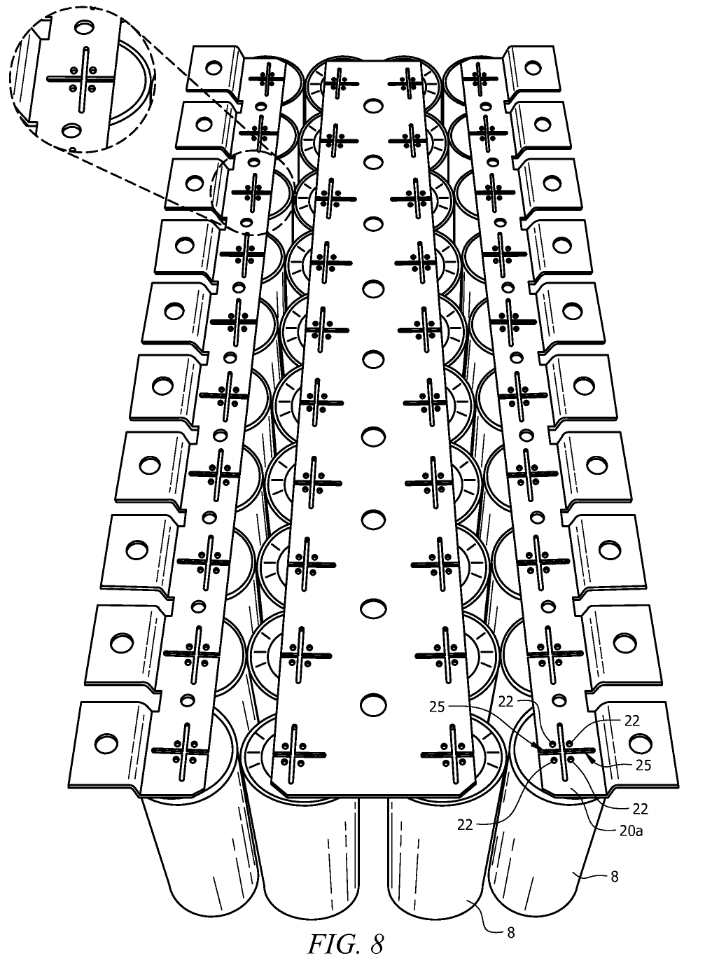

FIG. 8 illustrates a perspective view of the improved battery terminal strip 20a welded to terminals of battery cells 8. The pattern of cross-shaped cuts 25 concentrates energy to the weld dimples 22. During welding, two features improve the ability to weld: the dimples 22 and the cross-shape cuts 25. Additionally, the flow of heat from the welder into the battery cells 8 is reduced by the dimples 22 and the cross-shape cuts 25. Unlike the dimples 22, the cross-shape cuts 25 fully penetrate the material of the terminal strip 20a. In other words, there is a gap between the metal sheet 20a on a first side of a cross-shape cut 25 leg and the metal sheet 22a on a second side of a cross-shape cut 25 leg.

As previously described, the weld points 22 are formed indentations in the terminal strips 20a made either by molding or forming a metal strip made of, for example, steel, nickel, brass, copper or an alloy of such. The weld points 22 have protrusions extending out from a surface that contacts the battery terminal 9/11. The protrusions separate the terminal strip 20 from the battery cell terminals 9/11, providing an air gap between the battery cell terminals 9/11 and the bottom surface of the terminal strip 20a. In one embodiment, the weld points 22 protrude approximately 0.006 inches from the surface of the terminal strip 20a, though any depth of weld point 22 is anticipated.

It is difficult to weld two similar metals. Typically, the battery cell terminals 9/11 are made of nickel or a nickel alloy. Likewise, the terminal strip 20a is also, in some embodiments, made of a nickel or nickel alloy. In order to provide ample heat from the spot welder, it is desired that current flows from the anode of the spot welder, through the terminal strip 20a, across the battery terminal 9/11, back through the terminal strip 20a and out of the cathode of the spot welder.

To facilitate proper welding, the spot welder discharges energy between two of the weld points 22, and, at least some of the current from the spot welder flows from the anode of the spot welder, through the terminal strip 20a at the protrusion of a first weld point 22, across the battery terminal 9/11, back through the terminal strip 20a at a different protrusion of a second weld points 22 and out of the cathode of the spot welder, thereby fusing the protrusions of the weld points 22 to the battery terminal 9/11. The terminal strip cross-cuts 25 direct the current through the battery terminal 9/11 instead of across the terminal strip 20a, while providing a sufficiently low impedance to provide ample current flow in/out of the batter cells 8 during use.

Because the terminal strip 20a is made of metal with a high heat transfer coefficient, during the welding process, residual heat readily conducts across the terminal strip 20. The weld points 22 create an air gap (e.g., a 0.006 inch air gap) between the terminal strip 20a and the battery terminals 9/11. Because air is a poor thermal conductor, the heat generated at the weld points 22 is conducted down the terminal strip 20a instead of being conducted through the battery cell terminal 9/11 and into the battery cell 8. The result is decreased heating of the battery cells 8. Eventually, the heat produced by welding is conducted into the air and neighboring battery cells 8, but this process is gradual. As a result, the maximum temperature allowed by the manufacturer of the battery cells 8 is not exceeded by the welds made at the battery cell 8.

The terminal strip cross-cuts 25 also provide an escape mechanism for gasses that build up within the battery cells 8 and escape from the battery vent holes 6 when, for example, the battery cell 8 is over-charged, over-discharged or damaged. In some embodiments, the terminal strip cross-cuts 25 are formed or molded in the terminal strip 20a. The terminal strip cross-cuts 25 align with the vent holes 6 in the battery cells 8 to provide maximum exhaust surface area should venting occur.

Each leg of the cross-cut 25 passes between two adjacent weld points 22. For example, with four weld points 22, the one leg of the cross-cut 25 passes between a first and second, a second leg of the cross-cut 25 passes between a second and third weld point 22, a third leg of the cross-cut 25 passes between a third and fourth weld point 22, and a fourth leg of the cross-cut 25 passes between the first and fourth weld point 22. Although four weld points 22 and an X-shaped cross-cut 25 are shown, any number of weld points 22 and any form of cross-cut 25 are anticipated. For example, three weld points 22 and a cross-cut 25 having three legs.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A battery terminal strip for connecting to terminals of a plurality of battery cells, the strip comprising:
a strip of metal having four weld point formed in the strip of metal for each terminal of the battery cells, each of the weld points having a protrusion protruding from a first surface of the strip of metal such that the protrusion contacts the terminal of the battery cell, thereby forming an air gap between the first surface of the strip of metal and the terminal of the battery cell, thereby reducing heat transfer from the strip of metal to the battery cells during welding;
a cross-cut in the strip of metal, each segment of the cross-cut creating a gap in the strip of metal, each gap being between two different weld points of the four weld points.

2. The battery terminal strip of claim 1, wherein the protrusion extends outwardly 0.006 inches from the first surface.

3. The battery terminal strip of claim 1, wherein the weld points are fabricated by punching the strip of metal from an opposing surface to the first surface.

4. The battery terminal strip of claim 1, wherein the strip of metal is made from metal selected from the group consisting of steel, nickel, brass and copper.

5. A method of connecting a battery cell to a terminal strip, the method comprising:
positioning a battery terminal strip having four weld points against a battery terminal of the battery cell such that protrusions of the weld points contact a surface of the battery terminal and an air gap separates the remainder of the terminal strip from the battery terminal, the battery terminal strip including a cross-cut gaps that separates each weld point from its adjacent weld points;
fusing the protrusions of the weld points to the battery terminal by discharging a spot welder sequentially at each of the weld points.

6. The method of claim 5, wherein the protrusion extends outwardly 0.006 inches from the first surface.

7. The method of claim 5, further comprising a step of waiting for cooling of the terminal strip and battery terminal after each repetition of fusing each of the protrusions of the weld points.

8. The method of claim 5, wherein the step of fusing uses a spot welder.

9. The method of claim 8, wherein the spot welder uses a resistive electrode made of molybdenum.

10. A battery terminal strip for connecting to a terminal of at least one battery cell, the strip comprising:
a strip of metal having sets a plurality of weld points formed in the strip of metal, each of the weld points protruding from a first side of the strip of metal such that the weld points extend outwardly from the surface of the first side of the strip of metal, and such that an air gap will exist between the first surface of the strip of metal and an object to which the strip protrusions contact,
whereas there are gaps in the strip of metal between each two of the four points and the gaps with each other.

11. The battery terminal strip of claim 10, wherein the protrusion extends outwardly 0.006 inches from the first surface.

12. The battery terminal strip of claim 10, wherein the weld points are fabricated by punching the strip of metal from an opposing surface to the first surface.

13. The battery terminal strip of claim 10, wherein the strip of metal is made from metal selected from the group consisting of steel, nickel, brass and copper.

14. The battery terminal strip of claim 10, wherein the strip of metal is made from metal selected from the group consisting of steel, nickel, brass and copper.

15. The battery terminal strip of claim 10, wherein the plurality of weld points is four weld points.

16. The battery terminal strip of claim 10, wherein the plurality of weld points is three weld points.
